(19) United States
(12) Patent Application Publication
(10) Pub. No.: US 2014/0150222 A1
(43) Pub. Date: Jun. 5, 2014

(54) STRAP FOR SECURING CARGO ON A VEHICLE

(71) Applicant: Yakima Innovation Development Corporation, Georgetown Grand Cayman (KY)

(72) Inventor: Chris Sautter, Portland, OR (US)

(21) Appl. No.: 13/895,273

(22) Filed: May 15, 2013

Related U.S. Application Data
(60) Provisional application No. 61/647,327, filed on May 15, 2012.

(51) Int. Cl. B60P 7/135

(52) U.S. Cl. CPC B60P 7/135
USPC 24/69 CT

(57) ABSTRACT

A strap device and method of use thereof for securing cargo on a vehicle. The strap device includes a tension device for receiving a first end portion of a strap, and a quick connect device having a first member connected to the tension device and a second member connected to a second end portion of the strap. The members of the quick connect device being selectively connectable to create a circuit in the strap for binding cargo, wherein tension in the circuit prevents the members of the quick connect device from being disconnected.

### CROSS-REFERENCE TO RELATED APPLICATIONS

This application claims priority under 35 U.S.C. §119(e) to U.S. Provisional Patent Application Ser. No. 61/647,327 filed May 15, 2012 and is incorporated herein by reference in its entirety for all purposes.

This application also incorporates by reference in their entireties the following U.S. patent applications and patents: U.S. Pat. No. 6,385,822 filed Apr. 19, 2000; U.S. Pat. No. 6,543,096 filed Mar. 2, 2001; U.S. Pat. No. 8,234,757 filed Jun. 26, 2009; U.S. Publication No. US-2011-0219826-A1 published Sep. 15, 2011; and U.S. Publication No. US-2012-0321409-A1 published Dec. 20, 2012.

### INTRODUCTION

People frequently carry cargo on vehicles. Specialized racks are available for securing recreational items typically on top or on the rear of vehicles, such as on a vehicle roof or over (or in) a truck bed. Carrying cargo outside the vehicle is a convenient way to increase carrying capacity, particularly considering current trends to drive smaller, more fuel efficient vehicles, and particularly with respect to inherently large items that usually don't fit well inside a vehicle, for example, boats, bikes, skis, and surfboards.

Some cargo items require straps to bind things to a rack or to an external surface of a vehicle. For example, straps are typically used to secure boats, surfboards, and paddleboards on top of vehicles. Straps are also commonly used to secure baggage to external racks.

### SUMMARY

Disclosed herein is a strap device and method of use thereof for securing cargo on a vehicle. The strap device may include a tension device for receiving a first end portion of a strap, and a quick connect device having a first member connected to the tension device and a second member connected to a second end portion of the strap. The members of the quick connect device may be selectively connectable to one another to create a circuit in the strap for binding cargo. The circuit may be operable between a slacked position and a tensioned position. For example, the circuit may be shortened by pulling the first end portion of the strap further through the tension device to shorten the length of the strap included in the circuit.

A strap device may include a quick connect device that allows for the circuit to be created in the strap device while a portion of the strap remains threaded through the tension device.

The quick connect device may be configured to be secured in a connected position by creating tension in the circuit. For example, disconnecting the members of the quick connect device may involve relative rotation and/or translation of the members which may first require creating slack in the circuit.

In some embodiments, the strap device may include theft resistant components, such as a theft resistant strap and/or buckle assembly, as described in U.S. Publication No. US-2012-0321409-A1; U.S. Pat. No. 8,234,757; and U.S. Publication No. US-2011-0219826-A1, which are hereby incorporated by reference.

### DRAWINGS

FIG. 1 is a perspective view of a rack including a strap device for securing cargo on a vehicle, according to the present disclosure.

FIG. 2 is a perspective view of first and second buckle portions of the strap device of FIG. 1 in a disconnected position.

FIG. 3 is a perspective view of the first buckle portion of FIG. 2 flipped to show an opposite side of the first buckle portion.

FIG. 4 is a cross-section of the first buckle portion taken in the plane 4-4 in FIG. 2.

FIG. 5 is a plan view of the first and second buckle portions in an inserted position.

FIG. 6 is a plan view of the first and second buckle portions in a translated position.

FIG. 7 is a plan view of the first and second buckle portions in a secured position.

FIG. 8 is an elevation view of the first and second buckle portions in the secured position with a cut away in the first buckle portion to show open and closed positions of a tension device.

FIG. 9 is a flow chart depicting a method of securing cargo on a vehicle rack, according to the present disclosure.

### DESCRIPTION

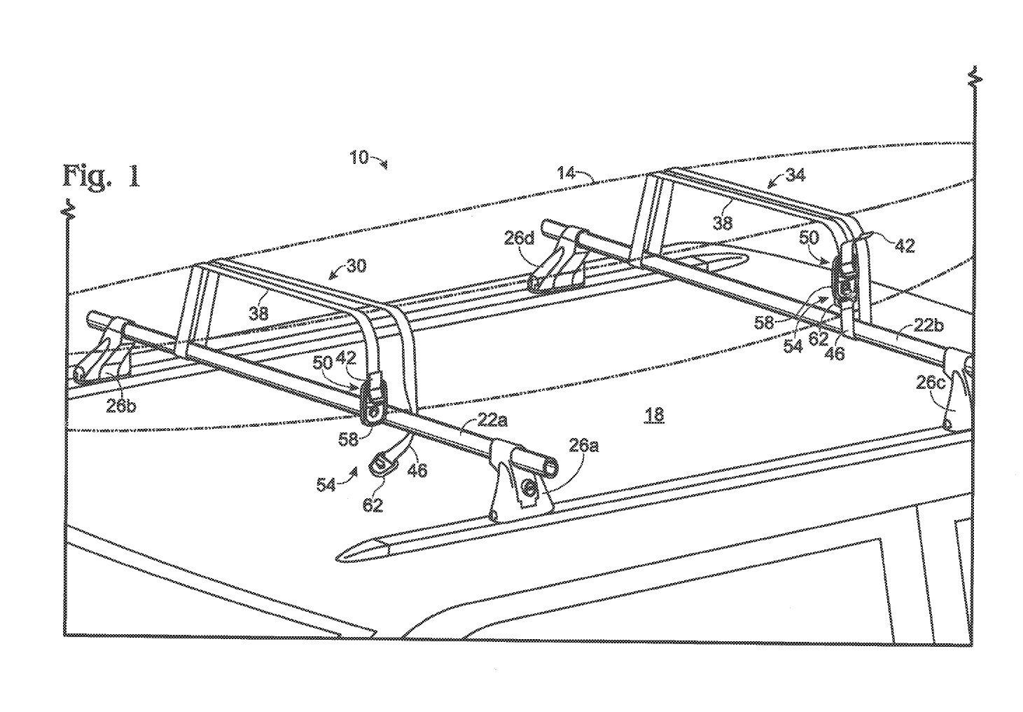

FIG. 1 shows a rack 10 for securing cargo or a load 14 (shown here as a boat in phantom) on a vehicle 18. Rack 10 includes a pair of crossbars 22a, 22b mounted to vehicle 18 by towers 26a-d. As shown, rack 10 includes first and second strap devices 30, 34 for binding or securing load 14 to crossbars 22a, 22b.

As shown in FIG. 1, strap devices 30, 34 are identical in structure and each include a strap 38 having a first end portion 42 and a second end portion 46, a tension device 50 for receiving and securing first end portion 42 of strap 38, and a quick connect device 54 for selectively connecting second end portion 46 of strap 38 to tension device 50. Tension device 50 and quick connect device 54 may be referred to as a buckle device.

As shown, quick connect device 54 includes a first buckle portion or member 58 rigidly connected to tension device 50 and a second buckle portion or member 62 connected to second end portion 46 of strap 38. Tension device 50 and first buckle portion 58 may be referred to as a first strap retainer. Second buckle portion 62 may be referred to as a second strap retainer. The second strap retainer may be non-adjustably fastened to second end portion 46 of strap 38.

In some embodiments, first buckle portion 58 may be non-rigidly connected to quick connect device 54. For example, first buckle portion 58 may be connected to tension device 50 by a strap or other suitable apparatus, structure, or mechanism for non-rigidly connecting first buckle portion 58 to tension device 50.

As shown in FIG. 1, quick connect device 54 of first strap device 30 is in a disconnected position, and quick connect device 54 of second strap device 34 is in a connected or secured position. As shown, the disconnected position allows the strap device to be wrapped around a crossbar and the load, and the connected position creates a circuit in the strap device for binding the load to the crossbar.

Tension device 50 may be configured to tighten the circuit to bind load 14 to rack 10. For example, pulling first end portion 42 of strap 38 through tension device 50 of second strap device 34 may be configured to tighten (or shorten) the circuit in strap device 34 to move the circuit from a slacked position to a tensioned position to bind (or secure) load 14 to crossbar 22b.

The slacked position may correspond to a greater length of strap 38 being included in the circuit to provide slack in the circuit so that the circuit (or strap) is ‘loose’ around load 14, whereas the tensioned position may correspond to a shorter length of strap 38 being included in the circuit (as compared to the slacked position) to tighten the circuit, thereby binding load 14 to rack 10. For example, FIG. 1 shows strap device 30 as having a shorter length of first end portion 42 of strap 38 pulled through tension device 50 than strap device 34. If quick connect device 54 of strap device 30 was moved to the connect position, then the circuit created in strap device 30 may be in the slacked position because a greater length of strap 38 would be included in the circuit (e.g., as compared to the circuit of strap device 34 as shown in FIG. 1).

To move strap device 30 from the disconnected position (as shown) to the tensioned position, a user may wrap second end portion 46 around crossbar 22a and connect first member 58 to second member 62 to create the circuit. The user may then pull first end portion 42 through tension device 50 to shorten the length of strap 38 included in the circuit to move the circuit from the slacked position to the tensioned position.

The tensioned position of the circuit may be configured to secure quick connect device 54 in the connected position. For example, first buckle portion 58 may be selectively connectable to second buckle portion 62 in the slacked position of the circuit, but not in the tensioned position of the circuit. In other words, disconnecting first buckle portion 58 from second buckle portion 62 may require slack in the circuit. For example, quick connect device 54 may be configured to increase tension in the circuit when moved from the connected position to the disconnected position. However, if the circuit is already tensioned around the load (e.g., in the tensioned position), a restorative force of load 14 acting upon the strap device may prohibit the tension in the circuit from being increased, thereby preventing quick connect device 54 from moving to the disconnected position. Examples of movements that may increase tension in the circuit include relative translation of second buckle portion 62 toward tension device 50, and relative rotation of second end portion 46 of strap 38 toward first end portion 42 of strap 38.

Strap device 30 and/or 34 may include any suitable structure, apparatus, or mechanism to deter a thief from removing the respective strap device and/or load 14 from rack 10. For example, strap 38 may include a steel cable embedded in an extruded plastic form with the plastic sewn inside woven webbing as described in U.S. Pat. No. 8,234,757 and/or U.S Publication No. US 2012-0321409 A1 each of which is hereby incorporated by reference; and tension device 50 may include a lock assembly which when locked prevents strap 38 from being loosened as described in U.S. Publication No. US-2011-0219826-A1 and/or U.S. Publication No. US-2012-0321409-A1 each of which is hereby incorporated by reference.

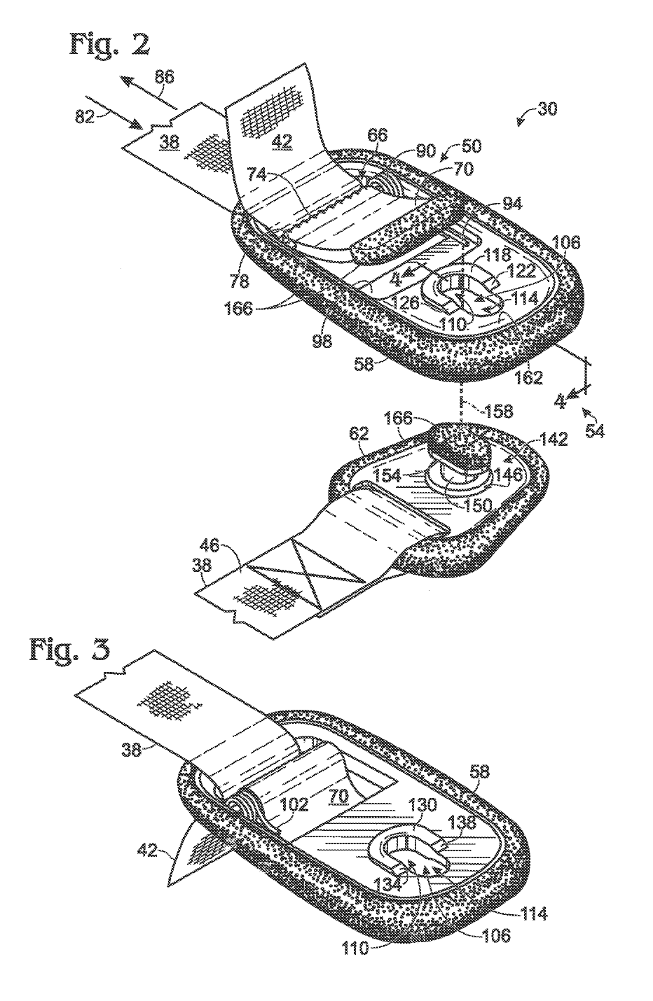

FIG. 2 shows a portion of strap device 30 in the disconnected position. As shown, tension device 50 includes a gap or aperture 66 for receiving first end portion 42 of strap 38, and a lever or spring-biased pawl lever 70 having teeth 74 configured to selectively impinge or pinch strap 38 against an edge of gap 66. For example, pawl lever 70 may be pivotable about an axle 78 between a closed position that pinches strap 38 in gap 66 and an open position that reduces a pinching force on strap 38 in gap 66 (see FIG. 8). FIG. 2 shows pawl lever 70 in the closed position.

The closed position of pawl lever 70 may be configured to allow strap 38 to be pulled through gap 66 in a first direction 82 resulting in tightening of the circuit, but not in a second direction 86 corresponding to a loosening direction. For example, the closed position of pawl lever 70 may be configured so that the impingement of teeth 74 on strap 38 is decreased when strap 38 is pulled through gap 66 in first direction 82, but increased by strap 38 being tensioned in second direction 86. As shown, pawl lever 70 is biased towards the closed position by a spring 90 disposed around axle 78. Spring 90 has a first spring arm 94 configured to press against a recessed ledge 98 of first buckle portion 58, as shown in FIG. 2, and a second spring arm 102 (see FIG. 3) configured to press against pawl lever 70 to bias pawl lever 70 towards the closed position.

Lever 70 may be described as having teeth 74 biased toward pinching a portion of strap 38 in aperture 66, permitting strap 38 to slide through aperture 66 in a tightening direction 82 but not in a loosening direction 86 when teeth 74 contact strap 38.

Alternatively, tension device 50 may include any suitable structure, apparatus, or mechanism for tensioning the circuit. For example, tension device 50 may include a ‘pants-style’ belt buckle, a ratcheting device, a hook and loop fastener, or any other suitable fastening, latching, or gripping device or mechanism configured to allow the circuit to be tensioned.

As shown in FIGS. 2-3, first buckle portion 58 includes an oblong shaped opening or hole 106 having a first opening portion 110 opposite a second opening portion 114. First opening portion 110 is closer to tension device 50 than second opening portion 114, as shown. Hole 106 may be described as being in the first strap retainer.

Opening 106 has a first ‘C’ shaped ridge 118 terminating with first and second ramps 122, 126 on a ‘top’ or first side of opening 106 (see FIG. 2), and a second ‘C’ shaped ridge 130 terminating with first and second ramps 134, 138 on a ‘bottom’ or second side of opening 106 (see FIG. 3). As shown, both first and second ridges 118, 130 extend around first opening portion 110, resulting in first opening portion 110 having a greater depth than second opening portion 114.

As shown in FIG. 2, second buckle portion 62 includes a T-pin 142 dimensioned to be inserted into opening 106 of first buckle portion 58. T-pin 142 includes a plateau 146 connected to second buckle portion 62, a post or post member 150 connected to plateau 146, and a bar or head piece 154 connected to post 150 opposite plateau 146. Post member 150 may be described as being on the second strap retainer and having head piece 154.

In some embodiments, post 150 may be connected to second buckle portion 62, or post 150 may include a beveled neck portion connected to plateau 146. The beveled neck portion of post 150 may be configured to interface with a beveled edge or perimeter of the second side (or first side) of opening 106.

Each of the strap retainers may be described as having a control plane. The control planes of the strap retainers may be defined by respective surfaces of the strap retainers and/or interfaces between the strap retainers. For example, the control plane of the second strap retainer may be defined by plateau 146 and/or another surface of second buckle portion 62. The control plane of the first strap retainer may be defined by a surface of first or second side of the second strap retainer (e.g., ridge 118, surface 162, ridge 130, and/or another surface of first buckle portion 58).

Each of the strap retainers may be described as having a tensioning axis passing through the retainer and through a portion of strap 38 connected to the retainer. For example, the first strap retainer may have a tensioning axis passing through first buckle portion 58 and through strap 38 substantially parallel to directions 82, 86, and the second strap retainer may have a tensioning axis passing through second buckle portion 62 and second end portion 46 of strap 38 substantially along an elongate direction of second end portion 46. In some embodiments, one or more of the tensioning axes may pass through one or more of the control planes.

As shown, hole 106 is an oblong (or oval) hole having a long axis (or length) substantially aligned with the tensioning axis of the first strap retainer. Head piece 154 is shown to be an oblong (or oval) head piece having a long axis (or length) not substantially aligned with the tensioning axis of the second strap retainer. For example, the long axis of head piece 154 may be perpendicular to the tension axis of the second strap retainer, as shown in FIG. 2.

Post member 150 may be described as orthogonally projecting from the control plane of the second strap retainer. A height of post member 150 may be defined as a distance between the control plane of the second strap retainer and an underside surface of head piece 154.

In some embodiments, plateau 146 may create an effective control plane from which post member 150 projects. For example, if plateau 146 has a width (or diameter) greater than a width of opening 106 (e.g., in a direction substantially perpendicular to the long axis of opening 106), then plateau 146 may create the effective control plane, in which case the height of post member 150 may be defined as a distance between the effective control plane and the underside surface of head piece 154.

As shown, bar 154 has a greater length than width to allow bar 154 to be inserted into opening 106 in a first orientation (shown in FIG. 2) but not a second orientation (e.g., second buckle portion 62 rotated 90 degrees from the first orientation about axis 158).

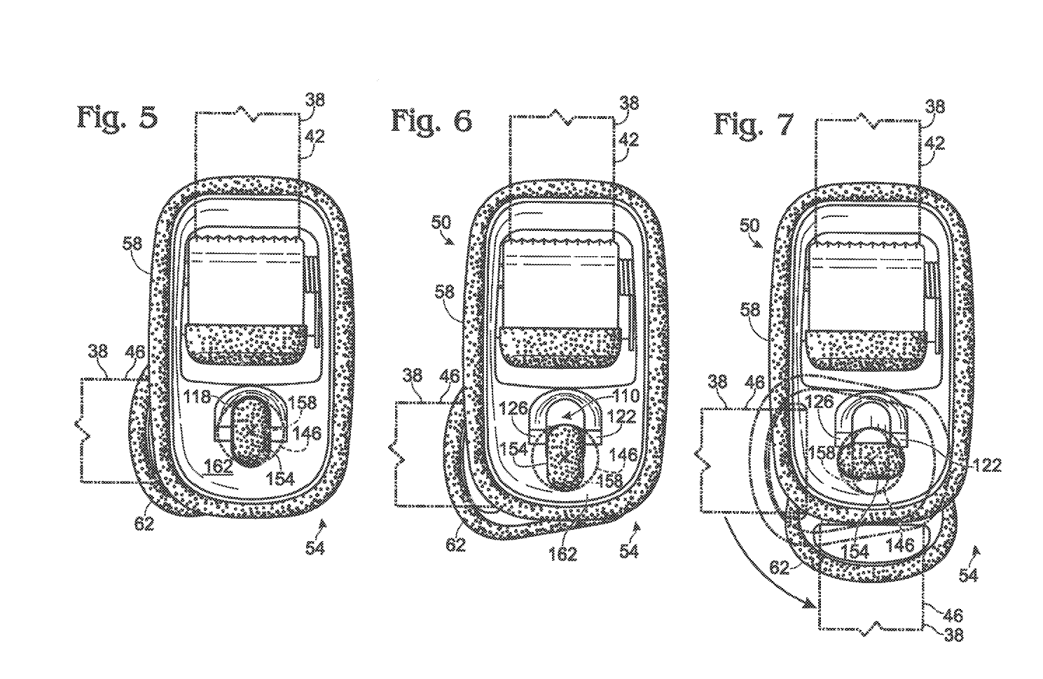

Hole 106 may be described as being dimensioned to permit head piece 154 to pass into (or through) hole 106 when the tensioning axes are not substantially aligned (see FIGS. 2 and 5), and to prevent head piece 154 from passing through hole 106 when the tensioning axes are substantially aligned (see FIGS. 7 and 8)

As indicated in FIG. 2, inserting T-pin 142 into opening 106 may include translating second buckle portion 62 ‘upward’ along axis 158 until plateau 146 contacts second ridge 130 (see FIG. 3), resulting in an inserted position of first and second buckle portions 58, 62. Post 150 may be dimensioned to prevent a portion of bar 154 from translating ‘above’ ridge 118, which may prevent bar 154 from rotating to the second orientation when in the inserted position.

Alternatively, T-pin 142 may be on or attached or connected to first buckle portion 58, and opening 106 may be in or formed in second buckle portion 62.

Alternatively, T-pin 142 and opening 106 may have other dimensions or shapes which may or may not correspond to one another. For example, bar 154 may be rectangular, square, triangular, star shaped, or oval, which may or may not be centered over post 150, and opening 106 may be shaped to receive the shaped bar in a first orientation but not a second orientation.

As shown in FIG. 2, opening 106 is dimensioned to approximate the shape of bar 154. In some embodiments, opening 106 may not approximate the shape of bar 154. For example, bar 154 may be an elongated rectangular shape with radiused opposing ends, as shown in FIG. 2, and opening 106 may be an elongated rectangular opening with non-radiused opposing ends.

As shown in FIG. 2, post 150 is a cylindrical post extending between plateau 146 and bar 150 along axis 158. In other embodiments, post 150 may have other shapes. For example, post 150 may have an irregular cross-section or may not extend along axis 158.

Alternatively, ridge 118 and/or 130 may be discontinuous and/or include one or more portions extending along one or more edges of opening 106. In some embodiments, quick connect device 54 may include one or more pegs or other protrusions located near opening 106 to prevent bar 154 from rotating to the second orientation when in the inserted position.

As shown in FIGS. 2-3, ridges 118, 130 are located on the edge of opening 106 to create a greater depth in first opening portion 110 than second end portion 114. In other embodiments, quick connect device 54 may include any suitable structure positioned or operable near opening 106 to prevent bar 154 from moving to the second orientation when in the inserted position, which may not necessarily vary the depth of opening 106.

Alternatively, quick connect device 54 may include any suitable structure, apparatus, or mechanism configured to selectively connect first member 58 to second member 62 for creating a circuit, wherein tension in the circuit prevents the members from being disconnected. For example, either of members 58, 62 may include an enlarged member, bar, or T-bar selectively slidable in a slot in the other member when circuit is in the slacked position but not the tensioned position, as shown in U.S. Provisional Patent Application Ser. No. 61/647,327. In some embodiments, first member 58 may include an enlarged member selectively connectable to a slot in second member 62, and/or second member 62 may include an enlarged member selectively connectable to a slot in first member 58.

When wrapping strap device 30 around a portion of load 14 and a portion of rack 10 (see FIG. 1), tension device 50 and/or quick connect device 54 may contact vehicle 18. For example, a user may wrap strap 38 around crossbar 22a, as shown, and then toss or throw first member 58 and/or second member 62 of quick connect device 54 over the load, which may result in either of first or second members 58, 62 contacting load 14 and/or vehicle 18. As shown in FIGS. 2-3 and subsequent figures, extremities or edge portions of tension device 50 and quick connect device 54 are covered, encased, or framed in a padding material 166 (e.g., elastomer, open-celled foam, plastic, or any suitable combination thereof) to protect load 14 and/or vehicle 18 from being scratched or otherwise damaged by hard, for example, metal components of strap device 30. For example, the first and second strap receivers (e.g., first and second buckle portions 58, 62) may each include an elastomeric frame around a metal body, and the height of the frame may be greater than a height of the body, as shown, to prevent the body from contacting a surface of vehicle 18. FIG. 2 shows the elastomeric frames as being generally rectangular frames.

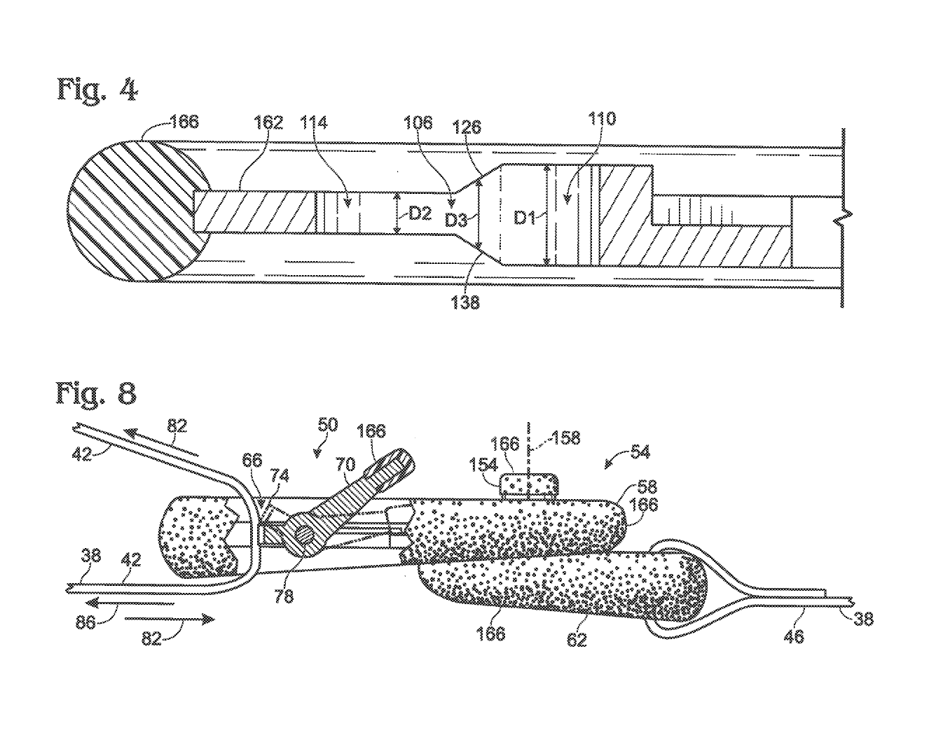

FIG. 4 shows a cross-section of opening 106 taken along plane 4-4 in FIG. 2. First opening portion 110 has a depth D1, and second opening portion 114 has a depth D2. As shown, depth D1 is taller than depth D2, and first ramp portions 126, 138 result in an intermediate depth D3 of opening 106, which is shorter than depth D1 and taller than D2. Ramp portions 122, 134 (see FIGS. 2-3) may similarly result in an intermediate depth of opening 106, which may be shorter than depth D1 and taller than D2. The height of post 150 (see FIG. 2) extending between plateau 146 and bar 154 may be dimensioned to be shorter than depth D1 to prevent second buckle portion 62 from substantially rotating (e.g., more than 45 degrees) about axis 158 in the inserted position.

FIG. 5 shows a top view of first and second buckle portions 58, 62 in the inserted position. As indicated, plateau 146 is dimensioned to contact second ridge 130 (see FIG. 3) in the inserted position. First ridge 118 may be configured to prevent bar 154 from substantially rotating (e.g., more than 45 degrees) about axis 158 when in the inserted position. As shown, first end portion 42 of strap 38 is approximately perpendicular to second end portion 46 of strap 38 in the inserted position.

The inserted position may be referred to as a first intermediated position between the disconnected position (see FIG. 1) and the secured position of quick connect device 54, which may provide a first level of security to hinder quick connect device 54 from inadvertently moving from the secured position to the disconnected position.

FIG. 6 shows a top view of first and second buckle portions 58, 62 in a translated position. As shown, second end portion 46 of strap 38 and second buckle portion 62 are translated (or slid) away from tension device 50 (and first end portion 42 of strap 38) to move post 150 (see FIG. 2) and axis 158 to second end portion 114 of opening 106 resulting in the translated position of quick connect device 54.

The height of post 150 (see FIG. 2) may be dimensioned to be taller than or equal to depth D2 (see FIG. 4) to allow second buckle portion 62 to be translated relative to first buckle portion 58 from the inserted position to the translated position, as shown in FIG. 6, causing bar 154 to extend ‘above’ second opening portion 114 and a surface 162 of first buckle portion 58 adjacent opening 106. In some embodiments, post 150 may be dimensioned to contact the radiused wall portion of second opening portion 114 (see FIG. 2) in the translated position.

As indicated in FIG. 6, plateau 146 is dimensioned to contact ramps 134, 138 of second ridge of second ridge 130 (see FIG. 3). For example, a beveled edge of plateau 146 (see FIG. 2) may be dimensioned to form a sliding interface with one or more of ramps 134, 138 in at an intermediate depth of opening 106 (e.g., depth D3—see FIG. 4) in the translated position.

The translated position may be referred to as a second intermediate position between the disconnected position (see FIG. 1) and the secured position of quick connect device 54. The second intermediate position may provide a second level of security to hinder quick connect device 54 from inadvertently moving from the secured position to the disconnected position.

FIG. 7 shows a top view of first and second buckle portions 58, 62 moving from the translated position (shown in phantom) to the secured position (shown in solid). As shown, moving quick connect device 54 from the translated position to the secured position involves rotating second buckle portion 62 (and second end portion 46 of strap 38) relative to first buckle portion 54 (and first end portion 42 of strap 38) to the second orientation (shown here as rotated 90 degrees relative to the first orientation about axis 158—see FIG. 5). A rotation such as this may decrease tension in the circuit, for example, by aligning second end portion 46 of strap 38 substantially parallel to first end portion 42 of strap 38. In contrast, rotation from the secured position to the translated position may increase tension in the circuit, for example, by pulling first and second end portions 42 and 46 of strap 38 closer together.

As shown, the long axis of hole 106 (see FIG. 2) is not substantially aligned with the long axis of head piece 154 when the tensioning axes of the first and second strap retainers are aligned (or substantially aligned).

In some embodiments, rotating first and second buckle portions 58, 62 from the first orientation to the second orientation may include a rotation greater or less than 90 degrees about axis 158 and/or any other suitable axis about which rotation involves varying (e.g., decreasing) the tension in the circuit.

In the secured position, second end portion 42 of strap 38 may be pulled through tension device 50 to reduce the length of strap 38 included in the circuit to move the circuit from the slacked position to the tensioned position (or tensioned configuration) for binding load 14. Tension in strap 38 in the tensioned position may prevent quick connect device 54 from rotating back to the translated position, thereby securing quick connect device 54 in the secured (or connected) position.

As shown, the tensioning axis of the first strap retainer is substantially aligned with the tensioning axis of the second strap retainer in the tensioned configuration.

In some embodiments, the tensioned position may be configured to pull post 150 (see FIG. 2) against the radiused wall portion of second opening portion 114 (see FIGS. 2 and 4).

In some embodiments, second opening portion 114 may include one or more detents or recesses configured to retain bar 154 and/or plateau 146 in the secured and/or tensioned position. For example, second opening portion 114 may include opposing recesses dimensioned to receive opposing end portions of bar 154 when in the secured position, as shown in U.S. Provisional Patent Application Ser. No. 61/647,327.

Quick connect device 54 may be configured to hinder but not prevent first and second buckle portions 58, 62 from moving (e.g. rotating about axis 158) between the translated and secured positions. For example, FIG. 7 shows rotation of second buckle portion 62 relative to first buckle portion 58 from the translated to the secured position as causing bar 154 to frictionally engage ramp 126 at a point where opening 106 has an intermediate depth, such as depth D3 (see FIG. 4). Rotating quick connect device 54 from the secured position to the translated position or another position (e.g., second buckle portion 62 rotated 90 degrees clockwise from the secured position in FIG. 7) that allows bar 154 to be translated back to the inserted position, may involve bar 154 frictionally engaging either of ramps 122, 126, and plateau 146 frictionally engaging ramps 134, 138 (see FIG. 3). However, these frictional engagements may be configured so that a torque (or other force) provided by the user allows quick connect device 54 to be selectively moved between the translated and the secured positions.

In some embodiments, ridge 118 and ramps 122, 126 may have beveled edges along edge portions of opening 106 (see FIG. 2) to provide various transitional depths of opening 106 that interface with bar 154 as bar 154 rotates from the translated position to the secured position.

The frictional engagement between second buckle member 62 and ramps 122, 126, 134, and/or 138 may be referred to as a ramp gate, in that ramps 122, 126, 134, and/or 138 allow for selective passage between the translated and secured positions. The ramp gate may provide a third level of security that hinders quick connect device 54 from inadvertently moving from the secured position to the disconnected position (see FIG. 1).

FIG. 8 shows a side view of first and second buckle portions 58, 62 in the secured position and a portion of first buckle portion 58 and tension device 50 cut away to show tension device 50 moving between open (shown in phantom) and closed positions (shown in solid). As shown, pulling first end portion 42 of strap 38 through gap 66 in first direction 82 causes pawl lever 70 to pivot about axle 78 toward the open position, which reduces the impingement or pinching force of teeth 74 on strap 38. As described, pulling first end portion 42 through gap 66 tightens the circuit in the strap device to move the circuit from the slacked position to the tensioned position.

As described, the tensioned position of the circuit may be configured to prevent quick connect device 54 from moving from the secured position to the disconnected position. For example, tension in the circuit may prevent second end portion 46 of strap 38 from rotating relative to first buckle portion 58 about axis 158, which may prevent quick connect device 54 from moving to the translated position because such a rotation would increase the tension in the circuit on load 14 (see FIG. 1). As described, a restorative force provided by load 14 may act upon the circuit (and/or the frictional force of the ramp gate) to prevent such an increase in tension. As another example, tension in the circuit may prevent quick connect device 54 from moving between the translated position (see FIG. 6) to the inserted position (see FIG. 5), because such a movement translates second end portion 46 of strap 38 closer to first end portion 42 of strap 38, which may further tension the circuit around the load.

First and second buckle portions 58, 62 may be structured to hinder second end portion 46 of strap 38 from moving towards first end portion 42 of strap 38. For example, FIG. 8 shows first and second buckle portions 58, 62 as being tapered toward one another, such that moving second end portion 46 of strap 38 toward first end portion 42 (e.g., the portion of first end portion 42 in gap 66) may cause padding material 166 of second buckle portion 62 to frictionally engage padding material 166 of first buckle portion 58 to hinder such a movement.

As described, the closed position of tension device 50 may prevent strap 38 from being pulled through gap 66 in second direction 86. However, the user may depress pawl lever 70 to the closed position to allow strap 38 to be pulled through gap 66 in second direction 86 to loosen the circuit, and subsequently move quick connect device 54 to the disconnected position to disconnect the circuit, thereby allowing load 14 (see FIG. 1) to be unloaded from rack 10.

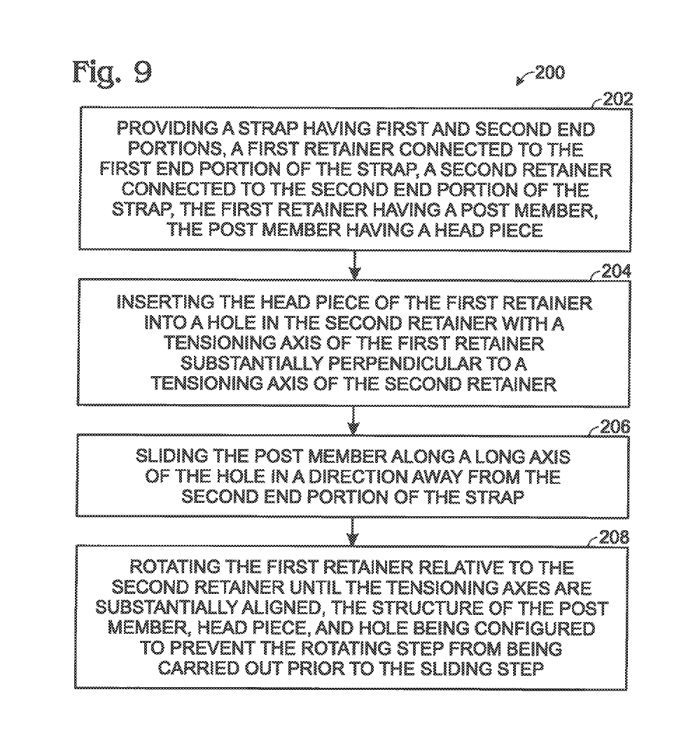

FIG. 9 depicts a method 200 of securing cargo on a vehicle rack, according to the present disclosure. Method 200 may include a step 202 of providing a strap having first and second end portions, a first retainer connected to the first end portion of the strap, and a second retainer connected to the second end portion of the strap. Each of the retainers may have a control plane and a tensioning axis passing through the retainer and through the connected strap portion in a tensioned configuration. The first retainer may have a post member orthogonally projecting from the control plane. The post member may have a head piece. The second retainer may have an oval shaped hole with a long axis substantially aligned with the tensioning axis of the second retainer and dimensioned to receive the head piece of the post member. The hole and the head piece each may have the same general oval shape.

Method 200 may include a step 204 of inserting the head piece into the hole with the tensioning axis of the first retainer substantially perpendicular to the tensioning axis of the second retainer, and a step 206 of sliding the post member along the long axis of the hole in a direction away from the second end portion of the strap.

Method 200 may include a step 208 of rotating the first retainer relative to the second retainer until the tensioning axes are substantially aligned, the structure of the post member, head piece, and hole being configured to prevent the rotating step from being carried out prior to the sliding step.

An embodiment of a method of binding a load, according to the present disclosure, may include a first step of providing a cargo rack, such as pair of crossbars mounted on a vehicle; and a second step of positioning the load on the cargo rack.

The method of binding a load may include a third step of providing a strap device having a tension device for receiving and selectively securing a first end portion of a strap, and a quick connect device having a first member connected to the tension device and a second member connected to a second end portion of the strap, wherein the first member is selectively connectable to the second member to create a circuit in the strap for binding the load.

The method of binding a load may include a fourth step of wrapping a first portion of the strap device around a first portion of the cargo rack, a fifth step of throwing one or more members of the quick connect device over the load; and a sixth step of wrapping a second portion of the strap device around a second portion of the cargo rack.

The method of binding a load may include a seventh step of connecting the first and second members of the quick connect device to create a circuit in the strap device; and an eighth step of tensioning (or tightening) the circuit with the tension device to bind the load to the cargo rack, wherein tension in the circuit prevents the first member of the quick connect device from being disconnected from the second member of the quick connect device.

A. A strap device for securing cargo on a vehicle rack comprising:

a strap having a first end portion and a second end portion,

a buckle device including a first strap retainer having a first aperture for receiving the first end portion of the strap,

a lever with teeth biased toward pinching a portion of the strap in the aperture, permitting the strap to slide through the aperture in a tightening direction but not in a loosening direction when the teeth contact the strap, and

a second strap retainer non-adjustably fastened to the second end portion of the strap, wherein each of the retainers has a control plane and a tensioning axis passing through the retainer and through the connected strap portion in a tensioned configuration, one of the retainers having a post member orthogonally projecting from the control plane, the post member having a head piece, the other retainer having a hole dimensioned to permit passing of the head piece through the hole when the tensioning axes of the retainers are not substantially aligned, and to prevent passing of the head piece through the hole when the tensioning axes of the retainers are substantially aligned.

A1. The strap device of claim A, wherein the head piece is oval, triangular, or rectangular.

A2. The strap device of claim A, wherein the hole is oval having a long axis which is not substantially aligned with a long axis of the head piece when the tensioning axes of the retainers are aligned.

A3. The strap device of claim A, wherein the hole is in the first strap retainer, and the post member is on the second strap retainer.

A4. The strap device of claim A, wherein the hole is in the second strap retainer, and the post member is on the first strap retainer.

A5. The strap device of claim A, wherein each retainer has an elastomeric frame around a metal body, the frame having a height which is greater than a corresponding height of the body to prevent the body from contacting a vehicle surface.

A6. The strap device of claim A, wherein the head piece has an elastomeric cap on top of a metal plate portion to prevent the plate portion from contacting a vehicle surface.

A7. The strap device of claim A, wherein the lever has an elastomeric coat on a metal distal end portion to prevent the metal distal end portion from contacting a vehicle surface.

A8. The strap device of clam A, wherein each retainer has a tapered thickness which decreases along the tensioning axis from an end portion connected to the strap toward an opposite end portion configured to engage the other retainer.

A9. The strap device of claim A, wherein the hole is oblong with a long axis substantially aligned with tensioning axis of the respective retainer.

A10. The strap device of claim A9, wherein the hole has a thickened rim portion proximal to an end portion connected to the strap and a thinned rim portion distal from the strap.

A11. The strap device of claim A10, wherein the post member has a height dimension from the control plane to the head piece, the height dimension of the post member being less than the thickness of the thickened rim portion and greater than the thickness of the thinned rim portion of the hole.

B. A strap device for securing cargo on a vehicle rack comprising:

a strap having a first end portion and a second end portion,

a buckle device including a first strap retainer having a first aperture for receiving the first end portion of the strap,

a lever with teeth biased toward pinching a portion of the strap in the aperture, permitting the strap to slide through the aperture in a tightening direction but not in a loosening direction when the teeth contact the strap, and

a second strap retainer non-adjustably fastened to the second end portion of the strap, wherein each of the retainers has a control plane and a tensioning axis passing through the retainer and through the connected strap portion in a tensioned configuration, one of the retainers having a post member orthogonally projecting from the control plane, the post member having a head piece, the other retainer having a hole dimensioned not to permit passing of the head piece through the hole when the strap and retainers are in a tensioned circuit, and to permit passing of the head piece through the hole when the strap and retainers are not in a tensioned circuit.

B1. The strap device of claim B, wherein the hole is dimensioned to prevent passing of the head piece through the hole when the tensioning axes of the retainers are substantially aligned, and to allow passing of the head piece through the hole when the tensioning axes of the retainers are not substantially aligned

B2. The strap device of claim B1, wherein the hole is dimensioned to allow passing of the head piece through the hole when the tensioning axes of the retainers are substantially orthogonal.

B3. The strap device of claim B, each of the retainers having a strap end portion and a coupling end portion, the hole having an oval shape, a proximal region of the hole toward the strap end portion, and a distal region of the hole toward the coupling end portion, the hole being configured to prevent rotation of the post member in the proximal region of the hole and to allow rotation of the post member in the distal region of the hole.

B4. The strap device of claim B3, wherein the hole has a depth which is greater in the proximal region than in the distal region.

B5. The strap device of claim B4, wherein the post member has a height from the control plane to the head piece, the height of the post member being smaller than the depth of the hole in the proximal region, and greater than the depth of the hole in the distal region of the hole.

B6. The strap device of claim B3, wherein the head piece has the same general shape as the hole, and is down-sized to permit the head piece to pass through the hole.

C. A method of securing cargo on a vehicle rack comprising:

providing a strap having first and second end portions,

a first retainer connected to the first end portion of the strap,

a second retainer connected to the second end portion of the strap, wherein each of the retainers has a control plane and a tensioning axis passing through the retainer and through the connected strap portion in a tensioned configuration, the first retainer having a post member orthoganally projecting from the control plane, the post member having a head piece, the second retainer having an oval shaped hole with a long axis substantially aligned with the tensioning axis of the second retainer and dimensioned to receive the head piece of the post member, the hole and the head piece each having the same general oval shape,

inserting the head piece into the hole with the tensioning axis of the first retainer substantially perpendicular to the tensioning axis of the second retainer,

sliding the post member along the long axis of the hole in a direction away from the second end portion of the strap, and

rotating the first retainer relative to the second retainer until the tensioning axes are substantially aligned, the structure of the post member, head piece, and hole being configured to prevent the rotating step from being carried out prior to the sliding step.

C11. The method of claim C, further comprising, resisting rotation of the post member during the rotating step by providing a raised edge portion around the hole.

C2. The method of claim C, wherein one of the retainers has a first aperture for receiving the first end portion of the strap, a lever with teeth biased toward pinching a portion of the strap in the aperture, permitting the strap to slide through the aperture in a tightening direction but not in a loosening direction when the teeth contact the strap, the method further comprising, pulling the strap through the aperture in the tightening direction after the rotating step.

C3. The method of claim C2, further comprising, pressing the lever to disengage the teeth from the strap, pulling the strap through the aperture in the loosening direction without completely removing the strap from the aperture, rotating the post member until the tensioning axes are substantially perpendicular to each other, sliding the post member along the long axis of the hole in a direction toward the second end portion of the strap, and removing the post member from the hole, allowing cargo to be removed from the vehicle rack.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the disclosure includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

We claim:

1. A strap device for securing cargo on a vehicle rack comprising:
a strap having a first end portion and a second end portion,
a buckle device including a first strap retainer having a first aperture for receiving the first end portion of the strap,
a lever with teeth biased toward pinching a portion of the strap in the aperture, permitting the strap to slide through the aperture in a tightening direction but not in a loosening direction when the teeth contact the strap, and
a second strap retainer non-adjustably fastened to the second end portion of the strap, wherein each of the retainers has a control plane and a tensioning axis passing through the retainer and through the connected strap portion in a tensioned configuration, one of the retainers having a post member orthogonally projecting from the control plane, the post member having a head piece, the other retainer having a hole dimensioned to permit passing of the head piece through the hole when the tensioning axes of the retainers are not substantially aligned, and to prevent passing of the head piece through the hole when the tensioning axes of the retainers are substantially aligned.

2. The strap device of claim 1, wherein the head piece is oval, triangular, or rectangular.

3. The strap device of claim 1, wherein the hole is oval having a long axis which is not substantially aligned with a long axis of the head piece when the tensioning axes of the retainers are aligned.

4. The strap device of claim 1, wherein the hole is in the first strap retainer, and the post member is on the second strap retainer.

5. The strap device of claim 1, wherein the hole is in the second strap retainer, and the post member is on the first strap retainer.

6. The strap device of claim 1, wherein each retainer has an elastomeric frame around a metal body, the frame having a height which is greater than a corresponding height of the body to prevent the body from contacting a vehicle surface.

7. The strap device of claim 1, wherein the head piece has an elastomeric cap on top of a metal plate portion to prevent the plate portion from contacting a vehicle surface.

8. The strap device of claim 1, wherein the lever has an elastomeric coat on a metal distal end portion to prevent the metal distal end portion from contacting a vehicle surface.

9. The strap device of clam 1, wherein each retainer has a tapered thickness which decreases along the tensioning axis from an end portion connected to the strap toward an opposite end portion configured to engage the other retainer.

10. The strap device of claim 1, wherein the hole is oblong with a long axis substantially aligned with tensioning axis of the respective retainer.

11. The strap device of claim 10, wherein the hole has a thickened rim portion proximal to an end portion connected to the strap and a thinned rim portion distal from the strap.

12. The strap device of claim 11, wherein the post member has a height dimension from the control plane to the head piece, the height dimension of the post member being less than the thickness of the thickened rim portion and greater than the thickness of the thinned rim portion of the hole.

13. A strap device for securing cargo on a vehicle rack comprising:
a strap having a first end portion and a second end portion,
a buckle device including a first strap retainer having a first aperture for receiving the first end portion of the strap,
a lever with teeth biased toward pinching a portion of the strap in the aperture, permitting the strap to slide through the aperture in a tightening direction but not in a loosening direction when the teeth contact the strap, and
a second strap retainer non-adjustably fastened to the second end portion of the strap, wherein each of the retainers has a control plane and a tensioning axis passing through the retainer and through the connected strap portion in a tensioned configuration, one of the retainers having a post member orthogonally projecting from the control plane, the post member having a head piece, the other retainer having a hole dimensioned not to permit passing of the head piece through the hole when the strap and retainers are in a tensioned circuit, and to permit passing of the head piece through the hole when the strap and retainers are not in a tensioned circuit.

14. The strap device of claim 13, wherein the hole is dimensioned to prevent passing of the head piece through the hole when the tensioning axes of the retainers are substantially aligned, and to allow passing of the head piece through the hole when the tensioning axes of the retainers are not substantially aligned

15. The strap device of claim 14, wherein the hole is dimensioned to allow passing of the head piece through the hole when the tensioning axes of the retainers are substantially orthogonal.

16. The strap device of claim 13, each of the retainers having a strap end portion and a coupling end portion, the hole having an oval shape, a proximal region of the hole toward the strap end portion, and a distal region of the hole toward the coupling end portion, the hole being configured to prevent rotation of the post member in the proximal region of the hole and to allow rotation of the post member in the distal region of the hole.

17. The strap device of claim 16, wherein the hole has a depth which is greater in the proximal region than in the distal region.

18. The strap device of claim 17, wherein the post member has a height from the control plane to the head piece, the height of the post member being smaller than the depth of the hole in the proximal region, and greater than the depth of the hole in the distal region of the hole.

19. The strap device of claim 16, wherein the head piece has the same general shape as the hole, and is down-sized to permit the head piece to pass through the hole.

20. A method of securing cargo on a vehicle rack comprising:
providing a strap having first and second end portions,
a first retainer connected to the first end portion of the strap,
a second retainer connected to the second end portion of the strap, wherein each of the retainers has a control plane and a tensioning axis passing through the retainer and through the connected strap portion in a tensioned configuration, the first retainer having a post member orthoganally projecting from the control plane, the post member having a head piece, the second retainer having an oval shaped hole with a long axis substantially aligned with the tensioning axis of the second retainer and dimensioned to receive the head piece of the post member, the hole and the head piece each having the same general oval shape,
inserting the head piece into the hole with the tensioning axis of the first retainer substantially perpendicular to the tensioning axis of the second retainer,
sliding the post member along the long axis of the hole in a direction away from the second end portion of the strap, and
rotating the first retainer relative to the second retainer until the tensioning axes are substantially aligned, the structure of the post member, head piece, and hole being configured to prevent the rotating step from being carried out prior to the sliding step.
